(19) United States
(12) Patent Application Publication
(10) Pub. No.: US 2013/0114582 A1
(43) Pub. Date: May 9, 2013

(54) WIRELESS MESH NETWORK DEVICE PROTOCOL TRANSLATION

(71) Applicant: Jordan Husney, Minneapolis, MN (US)

(72) Inventor: Jordan Husney, Minneapolis, MN (US)

(73) Assignee: Digi International Inc., Minnetonka, MN (US)

(21) Appl. No.: 13/288,692

(22) Filed: Nov. 3, 2011

(51) Int. Cl. H04W 80/00; H04L 12/56

(52) U.S. Cl. 370/338

(57) ABSTRACT

A wireless mesh network system includes a first wireless mesh network device supporting a first wireless mesh network device protocol. An application supporting a second wireless mesh network device protocol is executed, and a driver translates between the application's second wireless mesh network device protocol and the first wireless mesh network device protocol such that the application can exchange data with the first wireless mesh network device.

### FIELD OF THE INVENTION

The invention relates generally to wireless mesh networked devices, and more specifically in one embodiment to wireless mesh network device protocol translation.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Although computer networks have become relatively common both in office and in home networking environments, such networks are typically fairly sophisticated and require significant processing power, electrical power, and infrastructure to work well. Some networking applications do not require so robust a network environment, but can benefit from the ability to provide electronic communications between devices.

One such example is the Bluetooth technology that enables a cell phone user to associate and use an earpiece in what is sometimes referred to a personal area network or PAN. Another example is a mesh network, in which a number of devices work together to form a mesh, such that data can be sent from a source device to a destination device via other devices in the mesh network.

Mesh networks often include multiple links from a network node to other network nodes nearby, and can thereby provide routing around broken links or paths by discovering other routes through the mesh to a destination node. New nodes to a mesh network are typically able to automatically discover the mesh network when they are activated in the vicinity of a compatible mesh network, and can easily join the network. Mesh networks are often controlled by a coordinator device, such as a line powered device that acts as an interface between the mesh network and the Internet.

Mesh networks are often large, comprising tens or hundreds of nodes spread out over a wide area. Although each network node is able to communicate with neighboring nodes, the nodes typically will not be able to communicate with more than several other nodes in a typical network.

Network devices can also vary significantly in function, with different manufacturers providing devices that perform different functions and have different protocols to exchange data. For example, one company may provide a home automation thermostat that provides temperature, fan, furnace, and air conditioning control signals, and that receives programming information such as a target temperature and other zone temperature information from other thermostats. Another manufacturer's thermostat may provide similar data, but not include zone temperature capability while including humidity information and the ability to control a heat exchanger or air exchanger.

These examples illustrate why it is desirable to manage different types of devices in a wireless mesh network.

### SUMMARY

Some example embodiments of the invention comprise a wireless mesh network system including a first wireless mesh network device supporting a first wireless mesh network device protocol. An application supporting a second wireless mesh network device protocol is executed, and a driver translates between the application's second wireless mesh network device protocol and the first wireless mesh network device protocol such that the application can exchange data with the first wireless mesh network device.

### BRIEF DESCRIPTION OF THE FIGURES

FIG. 1 shows a wireless mesh network, consistent with an example embodiment of the invention.

FIG. 2 is a flowchart showing a method of establishing a secure wireless network connection between a joining device and a wireless network access point using an intermediary device via nearfield communication coupling to the joining device, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Mesh networks are often used to route data between various elements or nodes in a network made up of a number of loosely assembled nodes. Many mesh networks are designed such that a compatible node can easily join the network and receive and send data, including passing received data long a route to an intended destination node. Mesh networks are therefore often self-healing, in that if a node becomes inoperable or loses a connection to another node, data can be easily routed around the broken network link.

Many mesh network technologies use wireless communication, further enhancing the ease of use of mesh networking for certain applications. Because mesh network nodes are typically stationary, wireless connections between various nodes can be formed and characterized by searching a known frequency or radio band for other mesh network nodes as new wireless nodes are added to the mesh network. Recent reductions in cost and advancement in wireless networking technology has made use of mesh networking for a variety of applications a desirable alternative to using a more structured network such as a TCP/IP network.

One example of a mesh network standard using wireless radio communication is the ZigBee mesh network, which was developed by an industry alliance and is related to IEEE standards including 802.15.4. The retail price of ZigBee-compliant transceivers is nearly a dollar, and a transceiver, memory, and processor can be bought for a few dollars in quantity, making integration of mesh network technology into inexpensive electronic devices economically practical. The standard is intended to support low power consumption at reasonably low data rates, and provides a self-organizing network technology that works well for applications such as control, monitoring, sensing, and home automation.

In this example of wireless mesh technology, one node operates as a coordinator, forming the root of the mesh network and performing other functions such as bridging to other networks and handling encryption keys. Most nodes are router nodes, which can receive and send data, including passing data along to other nodes. In some embodiments, end device nodes contain just enough functionality to receive and send data, but cannot route or pass data from a sending node to a different receiving node. While this preserves battery life and reduces the cost of the node, end device nodes are unable to contribute to the routing functions of the mesh network, and so will typically not make up a large percentage of a mesh network's nodes.

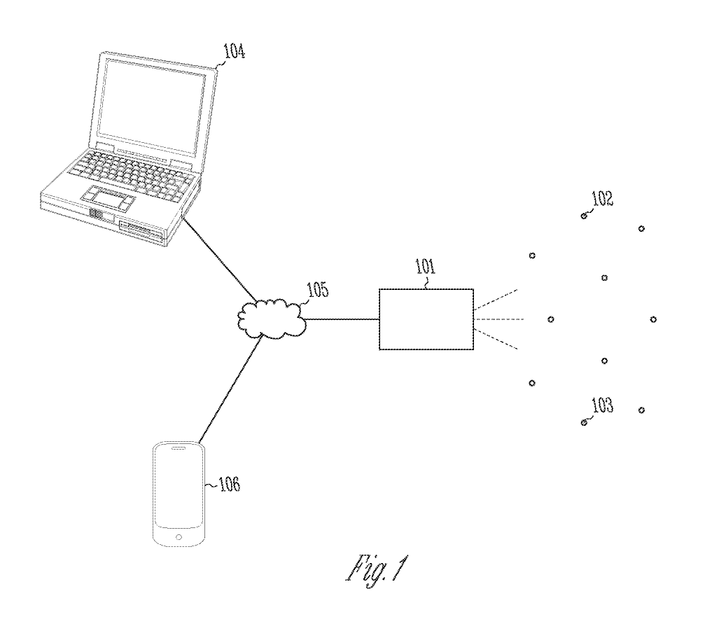

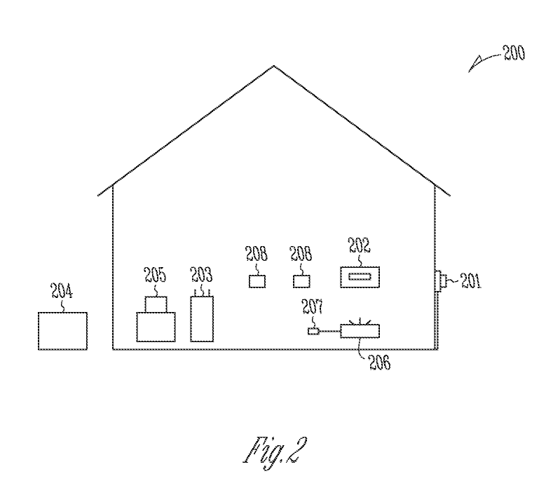

FIG. 1 is a diagram of a mesh network, consistent with an example embodiment of the invention. A gateway device 101 here includes a mesh network radio, and serves as a control node for the mesh network 102 as well as a bridge between the mesh network and an external network 105. A number of mesh network nodes 102 are distributed about an area within radio contact of one another, such as security monitoring devices within a store or warehouse, water monitoring devices distributed about a golf course or farm, or military surveillance devices distributed about a hostile area.

The gateway device 101 in this example is also linked to a computer system 104 via the Internet 105, such that the computer system is able to access the gateway 101 and configure the mesh network. In a further example, an Internet-enabled cell phone 106 is also able to access the gateway device 101 and configure or control the mesh network, enabling mesh network management from remote locations such as locations within the mesh network.

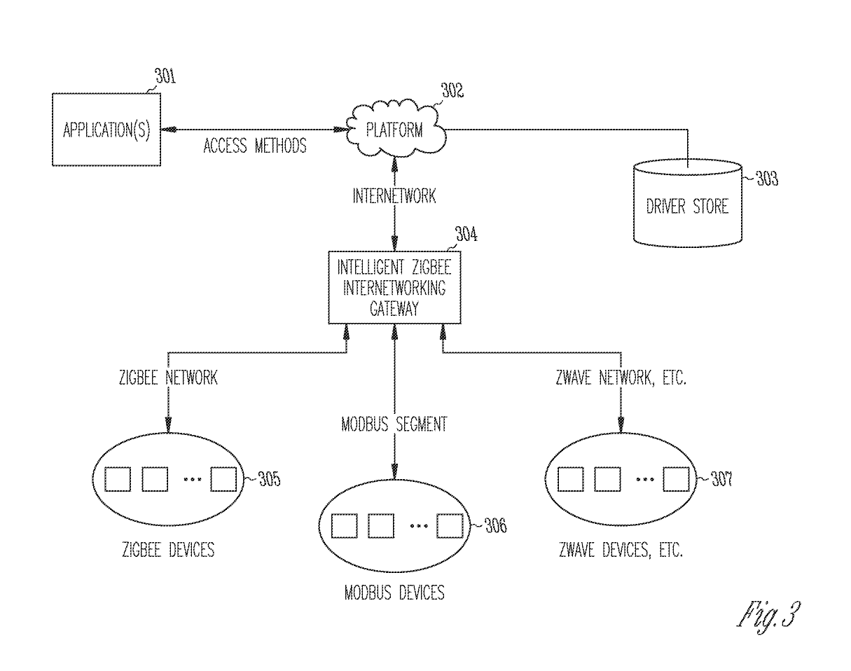

The mesh network in another example is a home automation network, such as is shown in FIG. 2. Here, a house 200 or other building is supplied power through a power meter 201, which includes a low bandwidth connection to the utility company used to exchange information such as power usage, pricing, and load control events. The low bandwidth connection is further coupled to various appliances within the home via a network, such as a wireless mesh network, including thermostat 202, water heater 203, air conditioner 204, and heat/ventilation system 205. The low data rate connection in the power meter is operable to send data to the utility company, such as power use information, and to receive information from the utility company, such as load control event information and pricing information. A mesh network module within the power meter is further operable to communicate with the appliances, such as the water heater 203 and air conditioner 204, and to control their operation in times of high power usage.

A high speed broadband connection 206 is provided by the homeowner, such as by providing a DSL, cable, wireless, or fiber Internet connection. Here, the home broadband router 206 is coupled to a bridge or gateway 207 that links the home broadband network to the mesh network linking the various appliances to one another. In a more detailed embodiment, the gateway device 207 communicates with a paired mesh network device placed in the power meter 201, which provides a secure connection between the home appliance network and the user's broadband network to protect the appliances within the home from unauthorized tampering via the mesh network. Additional mesh network appliance controls such as light controls 208 are also coupled to the home area mesh network.

In operation, a user such as a homeowner or building superintendent is able to manage the appliances via the broadband network, such as to turn the air conditioning or heat up or down, ensure that lights are on or off, turn the hot water heater temperature up or down, or perform other such functions via the Internet by using the bridge 207 coupled to a bridge or gateway device to the home's mesh appliance network via the power meter. Appliances within the network are also operable to send data via the Internet that would be too large or time consuming to send via a low-backhaul network, such as real-time power consumption to enable profiling of a home's power usage for use in predicting energy use or to provide guidance on saving energy. Home automation functions, such as appliance and light control via the Internet also enable a homeowner to perform tasks such as ensuring that appliances are set low when the house isn't in use, and restoring the appliance settings before the homeowners return home.

But, integration of such a wide variety of mesh network devices into even this simplified building environment of FIG. 2 can involve a mesh network controller device such as the thermostat 202 or an attached computer being able to understand and communicate with a variety of different devices provided by different manufacturers. The thermostat 202, lighting controls 208, water heater 203, furnace 205, and air conditioner 204 might each be from a different manufacturer, meaning that at least a controller device from one manufacturer should be able to understand data from a variety of devices from other manufacturers to make use of the data.

Rather than run separate control programs or controllers for each of these devices, some embodiments of the invention seek to allow a controller to interact with a wide variety of mesh network devices by providing an abstraction layer or interface protocol translation for different devices in a mesh network. For example, the air conditioner 203 may report inside temperature, outside temperature, power consumption, and load control programming information in a format unique to the air conditioner, while a controller such as thermostat 202 is able to receive the information and use air conditioner profile information to convert this data to a standard format understood by the thermostat controller 202.

Profile information is in some embodiments provided by the manufacturer of the thermostat or the air conditioner, such as by using device identifying information communicated from the air conditioner 204 to the controller, or by user or installer selection of the air conditioner device via a computerized system or controller. In a further example, the profile information is manually selected from a library of available profiles or is automatically downloaded via the high speed network 206 and gateway 207, enabling easy configuration of new devices using provided profile information.

FIG. 3 is a block diagram of a profile distribution system, consistent with an example embodiment of the invention. Here, one or more applications, such as a building automation and control application, desire a unified method of accessing the variety of different mesh network devices having different capabilities and provided by different manufacturers, as shown in the example of FIG. 2. A network-based platform 302 provides network accessibility to the applications 301, as well as to a store of drivers 303 having a variety of different drivers or descriptors for different devices, enabling protocol translation from each manufacturer or device's specific protocol to a generic or unified protocol understood by the control software 301. The driver in a further example provides a record of the capabilities of a specific device, distinguishing for example a thermostat that has humidity sensing capability from a thermostat that does not.

The driver therefore provides a layer of device abstraction between the device itself and the applications 301 as provided through network platform 302, enabling the application to address devices that use different communication protocols or commands as though they all communicated using the same unified command structure. Application developers can therefore create applications 301 to communicate with the unified device interface rather than being concerned with writing code for each specific brand and protocol of device that may be encountered, simplifying application development and support.

An intelligent gateway 304 provides an interface between a variety of mesh network devices such as ZigBee devices 305, Modbus devices 306, and ZWave Network devices 306 and the network platform 302. In a more detailed example, the connection between the intelligent gateway 304 and the platform 302 is the Internet, a cellular data network, or another such suitable network.

In operation, the intelligent gateway is operable to discover and identify devices on its mesh or other networks such as ZigBee devices 305 and Modbus devices 306, while reporting the identity of such devices to the platform 302 and facilitating data exchange between such devices and the platform. The platform is operable to use appropriate drivers from the driver store to interpret the data from the various devices managed by gateway 304, translating the protocol of the individual devices to a universal protocol understood by the applications 301.

If the intelligent gateway is unable to probe a networked device to determine its type or capabilities, it will in a further embodiment query the platform for additional information to identify or communicate with the device, such as by downloading probing or querying information for new devices from the platform 302. In other examples, features or functions of various elements of FIG. 3 may be moved to other elements, such as an application platform residing on the intelligent gateway 304, operable to use a driver store to run universal protocol applications on a gateway or controller device.

Creating a universal protocol accessible by applications in a more detailed example comprises creating a ZigBee or other single protocol representation of devices using other native protocols, such as Modbus devices at 306 or ZWave Devices products at 307. By using a driver to create a virtual ZigBee device that can translate commands to protocols used by other devices, applications 301 can be written as though every device on the network were a ZigBee device, while the abstraction layer drivers enable use of almost any type of device on any type of network.

The examples provided here show how use of protocol translation drivers for mesh network devices in a network such as a ZigBee network can enable a wide variety of devices from a variety of manufacturers and using a variety of networking technologies to be accessed and managed by a single gateway, platform, or universal application. Devices can be automatically discovered and added, such as by using the driver store and an intelligent gateway or controller, and legacy communication technologies or incompatible communication protocols can be integrated into a modern mesh network system.

Although specific embodiments have been illustrated and described herein, it will be appreciated by those of ordinary skill in the art that any arrangement which is calculated to achieve the same purpose may be substituted for the specific embodiments shown. The invention may be implemented in various modules and in hardware, software, and various combinations thereof, and any combination of the features described in the examples presented herein is explicitly contemplated as an additional example embodiment. This application is intended to cover any adaptations or variations of the example embodiments of the invention described herein. It is intended that this invention be limited only by the claims, and the full scope of equivalents thereof.

What is claimed is:

1. A method of operating a wireless mesh network device network, comprising:
operating a first wireless mesh network device supporting a first wireless mesh network device protocol;
executing an application supporting a second wireless mesh network device protocol;
providing a driver operable to translate between the application's second wireless mesh network device protocol and the first wireless mesh network device protocol such that the application can exchange data with the first wireless mesh network device.

2. The method of operating a wireless mesh network device network of claim 1, wherein the driver is employed by a networked application platform.

3. The method of operating a wireless mesh network device network of claim 1, wherein the driver comprises an abstraction layer between a command set of the application and a command set of the first wireless mesh network device.

4. The method of operating a wireless mesh network device network of claim 1, wherein the first wireless mesh network device is a device coupled to a wireless mesh network via a connected wireless mesh network interface.

5. The method of operating a wireless mesh network device network of claim 1, wherein the application executes on a wireless mesh network controller.

6. The method of operating a wireless mesh network device network of claim 1, further comprising automatically identifying the first wireless mesh network device by querying the device.

7. The method of operating a wireless mesh network device network of claim 1, further comprising automatically retrieving the driver from a networked driver store.

8. A wireless mesh network application platform, comprising:
a gateway providing an interface to a first wireless mesh network device supporting a first wireless mesh network device protocol;
an application platform coupled to the gateway by a network and operable to run an application in communication with the first wireless mesh network device and supporting a second wireless mesh network device protocol;
a driver operable to translate between the application's second wireless mesh network device protocol and the first wireless mesh network device protocol such that the application can exchange data with the first wireless mesh network device.

9. The wireless mesh network application platform of claim 8, wherein application platform and the gateway are coupled by the Internet.

10. The wireless mesh network application platform of claim 8, wherein the driver comprises an abstraction layer between a command set of the application and a command set of the first wireless mesh network device.

11. The wireless mesh network application platform of claim 8, wherein the first wireless mesh network device comprises a device coupled to a wireless mesh network via a connected wireless mesh network interface.

12. The wireless mesh network application platform of claim 8, wherein the application platform comprises a wireless mesh network controller.

13. The wireless mesh network application platform of claim 8, the gateway further operable to automatically identify the first wireless mesh network device by querying the device.

14. The wireless mesh network application platform of claim 8, the application platform further operable to automatically retrieve the driver from a networked driver store.

15. A machine-readable medium with instructions stored thereon, the instructions when executed operable to cause a computerized system to:
operate a first wireless mesh network device supporting a first wireless mesh network device protocol;
execute an application supporting a second wireless mesh network device protocol; and
provide a driver operable to translate between the application's second wireless mesh network device protocol and the first wireless mesh network device protocol such that the application can exchange data with the first wireless mesh network device.

16. The machine-readable medium of claim 15, wherein the driver comprises an abstraction layer between a command set of the application and a command set of the first wireless mesh network device.

17. The machine-readable medium of claim 15, wherein the first wireless mesh network device is a device coupled to a wireless mesh network via a connected wireless mesh network interface.

18. The machine-readable medium of claim 15, wherein the application executes on a wireless mesh network controller.

19. The machine-readable medium of claim 15, the instructions when executed further operable to cause the computerized system to automatically identify the first wireless mesh network device by querying the device.

20. The machine-readable medium of claim 15, the instructions when executed further operable to cause the computerized system to automatically retrieve the driver from a networked driver store.
